(19) United States
(12) Patent Application Publication
(10) Pub. No.: US 2026/0358517 A1
(43) Pub. Date: Nov. 12, 2026

(54) SYSTEMS AND METHODS FOR CONTAMINATION SAMPLING

(71) Applicant: ATKINS NUCLEAR SECURED HOLDINGS CORPORATION, Oak Ridge, TN (US)

(72) Inventors: Eric SMITH, Oak Ridge, TN (US); Kevin MAZE, Oak Ridge, TN (US)

(73) Assignee: ATKINS NUCLEAR SECURED HOLDINGS CORPORATION, Oak Ridge, TN (US)

(21) Appl. No.: 19/130,410

(22) PCT Filed: Nov. 15, 2023
(86) PCT No.: PCT/US2023/079728

§ 371 Date: May 15, 2025

Related U.S. Application Data
(60) Provisional application No. 63/425,559, filed on Nov. 15, 2022.

(51) Int. Cl. G01T 7/02; G01N 1/02

(52) U.S. Cl. CPC G01T 7/02; G01N 1/02; G01N 2001/022; G01N 2001/028

(57) ABSTRACT

A system for radioactive contamination sampling, comprising: a mounting tray for coupling to a robot for deployment in radioactive environments, and sampling container(s) releasably coupled to the tray to maintain a position of the container. Container(s) comprising: a cup, and a lid having a sampling surface configured to fit in the cup. The lid is releasably coupled to the cup by a sealing surface to seal the sampling surface inside, preventing contamination of the sampling surface. The sampling surface extends from the lid, and is configured to collect a sample from a surface. Each container also comprising an interface member coupled to the lid, the interface member shaped to be gripped by the robot and to pivot about the coupling point with the container lid.

### CROSS REFERENCE TO RELATED APPLICATION AND CLAIM OF PRIORITY

The present application claims priority to U.S. Provisional Patent Application No. 63/425,559 filed on Nov. 15, 2022, the entire contents of which are hereby incorporated by reference.

### TECHNICAL FIELD

The disclosure relates generally to sample collection, and more particularly to systems for radioactive contamination sampling.

### BACKGROUND

Contamination, and radioactive contamination in particular, exists in facilities using, processing, and storing radioactive materials. Radioactive contamination may be radioactive material (e.g., dust) that collects on surface of rooms and equipment of a facility. The concentration levels of contamination in an area of a facility should be determined to ensure that humans are not exposed to unsafe levels of radiation. Contamination levels can be determined by wiping (also referred to as smearing, swiping, or swabbing) a sample disc, commonly made of filter paper, over an area of fixed area. The contamination on the sample disc can then be tested with a radiation detector, commonly a Geiger-Muller counter, to determine the concentration of contamination.

Collection of the contamination samples is commonly performed by humans. During the process of collecting the samples, the human collecting the sample may be exposed to radiation and contamination of unknown amounts, which risks a radiation dose for the individual or unintended spreading of contamination out of the tested area. Further, determining the contamination level in an area normally requires personnel on each shift and on weekends at premium pay rates.

Therefore, improvements are needed.

### SUMMARY

In one aspect, the disclosure describes a system for radioactive contamination sampling. The system comprises: a mounting tray configured to be coupled to a robot for deployment in a radioactive environment; at least one sampling container configured to be releasably coupled to the mounting tray to maintain a position of the at least one sampling container during deployment of the robot. Each of the at least one sampling container comprises: a lid having a sampling surface for receiving a sample, and a cup, the sampling surface positioned on a first side of the container lid, the first side and the sampling surface each configured to fit within an inner volume of the cup, the container lid releasably coupled to the container cup by a sealing surface to seal the sampling surface within the inner volume and to prevent contamination of the sampling surface, the sampling surface positioned to extend away from the first side of the container lid, the sampling surface configured to collect a sample from a surface; and an interface member coupled to a second side of the container lid, the interface member having a shape configured to be gripped by an end effector of the robot, wherein the interface member is configured to pivot about the coupling with container lid.

In an embodiment, the system also comprises a hinge configured to pivot a longitudinal axis of the interface member at a first angle relative to a second axis orthogonal to a plane defined by the second side of the container lid. The first angle may be between 1-45 degrees. The hinge may be configured to rotate the interface member about the longitudinal axis through a second angle. The second angle can be between 1-45 degrees. The hinge may be configured translate the interface member axially along the longitudinal axis of the interface member. In an embodiment, the hinge is a hook and loop fastener.

In an embodiment, the sampling surface is configured to receive a sample paper.

In an embodiment, the interface member comprises a resilient compressible surface. The resilient compressible surface may have a frictional coefficient of greater than 0.4.

In an embodiment, the interface member comprises a substantially spherical surface.

In an embodiment, the interface member comprises a frustoconical shape.

In an embodiment, the interface member comprises an generally circular cross-section.

In an embodiment, the mounting tray has a mounting surface supporting the at least one sampling container, the mounting tray supported by at least one resilient mounting member for absorbing compressive, tensile, and shear force.

In an embodiment, the container lid comprises a shoulder projecting away from the sampling surface for receiving the sampling paper, the shoulder coupled to a lip having a concave surface for self-centering engagement with a rim of the cup; and wherein the rim of the cup comprises convex mating surface for engaging the concave surface of the lip. The shoulder may comprise a ridge or a groove for mating with the other of the ridge or the groove, and the rim comprises the other of the ridge or the groove. The lip having the concave surface may be configured to friction fit with the convex mating surface of the rim of the cup. In an embodiment, the rim of the cup comprises a flange. In another embodiment, the sampling surface is configured to releasably couple the sampling paper to a first side of the container lid with a fixing device.

In an embodiment, the system comprises the robot for deployment in a radioactive environment, the robot comprising the end effector coupled to an arm, wherein the mounting tray is coupled to the robot and positioned to be reachable by the arm.

Embodiments may include combinations of the above features.

In another aspect, the disclosure describes a sampling container for radioactive contamination sampling. The sampling container comprises: a container cup configured to be releasably coupled to a mounting tray on a robot for deployment in a radioactive environment to maintain a position of the at least one sampling container during deployment of the robot; a lid having a sampling surface, the sampling surface positioned on a first side of the container lid, the first side and the sampling surface each configured to fit within an inner volume of the cup, the container lid releasably coupled to the container cup by a sealing surface to seal the sampling surface within the inner volume and to prevent contamination of the sampling surface, the sampling surface positioned to extend away from the first side of the container lid, the sampling surface configured to collect a sample from a surface to be sampled; an interface member coupled to a second side of the container lid, the interface member having a shape configured to be gripped by an end effector of the robot, wherein the interface member is configured to pivot about the coupling with container lid.

In an embodiment, the sampling container comprises a hinge configured to pivot a longitudinal axis of the interface member at a first angle relative to a second axis orthogonal to a plane defined by the second side of the container lid. The first angle may be between 1-45 degrees. The hinge may be configured to rotate the interface member about the longitudinal axis through a second angle. The second angle may be between 1-45 degrees. In an embodiment, the hinge is configured translate the interface member axially along the longitudinal axis of the interface member. In an embodiment, the hinge is a hook and loop fastener.

In an embodiment, the sampling surface is configured to receive a sample paper.

In an embodiment, the interface member comprises a resilient compressible surface. The resilient compressible surface may have a frictional coefficient of greater than 0.4.

In an embodiment, the interface member has a generally spherical surface.

In an embodiment, the interface member comprises a frustoconical shape.

In an embodiment, the interface member comprises an generally circular cross-section.

In an embodiment, the container lid comprises a shoulder projecting away from the sampling surface, the shoulder coupled to a lip having a concave surface for self-centering engagement with a rim of the cup; and wherein the rim of the cup comprises convex mating surface for engaging the concave surface of the lip. The shoulder may comprise a ridge or a groove for mating with the other of the ridge or the groove, and the rim comprises the other of the ridge or the groove. The lip may having the concave surface may be configured to friction fit with the convex mating surface of the rim of the cup. The rim of the cup may comprise a flange.

Embodiments may include combinations of the above features.

In a further aspect, the disclosure describes a method for radioactive contamination sampling. The method comprises: extending an end effector of a robot arm toward a sampling container (e.g., those described above and below), the end effector positioned at an angle relative to a longitudinal axis of the interface member; gripping the interface member with the end effector; pivoting the interface member about its coupling point with the container lid; removing the container lid from the container cup; extending the container lid toward a surface to be sampled to contact the sampling surface with the surface to be sampled.

In an embodiment, the angle is 1-45 degrees.

In an embodiment, the method comprises coupling the container lid with the container cup to seal the sampling surface inside the sampling container.

In an embodiment, the method comprises contacting the sampling surface with the surface to be sample, wherein the longitudinal axis of the interface member is at an angle relative to the surface to be sample. The angle relative to the surface to be sampled may be between 45-90 degrees.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is front view illustrating a system for radioactive sampling, according to some embodiments;

FIG. 2 is a side view illustrating a mounting system, according to some embodiments;

FIG. 3 is a top view illustrating a system for radioactive sampling, according to some embodiments;

FIG. 4A is a fragmented view illustrating a sample container cup, according to some embodiments;

FIG. 4B is an assembled view of the sample container cup of FIG. 4A;

FIG. 5A is a fragmented view illustrating a sample container lid and swab holder, according to some embodiments;

FIG. 5B is an assembled view of the sample container lid and swab holder of FIG. 5A;

FIG. 6A is fragmented view illustrating an gripping assembly, according to some embodiments;

FIG. 6B is an assembled view of the gripping assembly of FIG. 6A;

FIG. 7A is a top view illustrating a sample container lid, according to some embodiments;

FIG. 7B is a bottom view of the sample container lid of FIG. 7A;

FIG. 7C is a front view of the sample container lid of FIG. 7A;

FIG. 8A is a top view illustrating a sample container cup, according to some embodiments;

FIG. 8B is a bottom view of the sample container cup of FIG. 8A;

FIG. 8C is a front view of the sample container cup of FIG. 8A;

FIG. 9 is an assembled view illustrating a sample container, according to some embodiments; and

FIG. 10A is a picture showing an example system for radioactive sampling implemented on a robot, according to some embodiments.

FIG. 10B is a picture showing an example system for radioactive sampling implemented on a robot, according to some embodiments.

FIG. 10C is a picture showing an example system for radioactive sampling implemented on a robot, according to some embodiments.

FIG. 11 is a flow chart illustrating a method for radioactive contamination sampling.

### DETAILED DESCRIPTION

This disclosure provides a system for collecting contamination samples, radioactive samples in particular, remotely, and returning them to the operator, which may allow determination of the concentration of radioactive contamination as well as determining the radionuclide makeup of the contamination.

This mitigates risk of exposure for individuals to contaminants, such as radiative contamination, and also reduces the risk of contaminating samples taken from an environment. The provided systems may completely remove the need for a human during the sampling procedure, thus eliminating potential excessive exposure to the unknown sources of radioactive contamination within an area being sampled. The provided systems may also reduce costs associated with sampling to determine contamination levels in an area.

### DEFINITIONS

Although terms such as “maximize”, “minimize” and “optimize” may be used in the present disclosure, it should be understood that such term may be used to refer to improvements, tuning, and refinements, which may not be strictly limited to maximal, minimal or optimal.

The term “connected” or “coupled to” may include both direct coupling (in which two elements that are coupled to each other contact each other) and indirect coupling (in which at least one additional element is located between the two elements).

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of+5%, +10%, +20%, or+25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The term “gripping assembly” refers to an interface member coupled to a sample container with a hinge which may allow the interface member to tilt and/or rotate with respect to the sample container.

Aspects of various embodiments are described through reference to the drawings.

According to some embodiments, the systems may provide for remote contamination sampling, allowing determination of concentration and radionuclide content. Using such a system, may allow people to not be exposed to radiation to obtain samples.

According to some embodiments, sampling containers, for example, may prevent cross contamination of collected samples without human exposure. A sample tray may be used to support the sampling containers in steady and/or fixed positions, while allowing for movement in the vertical and horizontal directions caused by normal or abnormal operations. The sample tray may also prevent damage to the systems described in this disclosure.

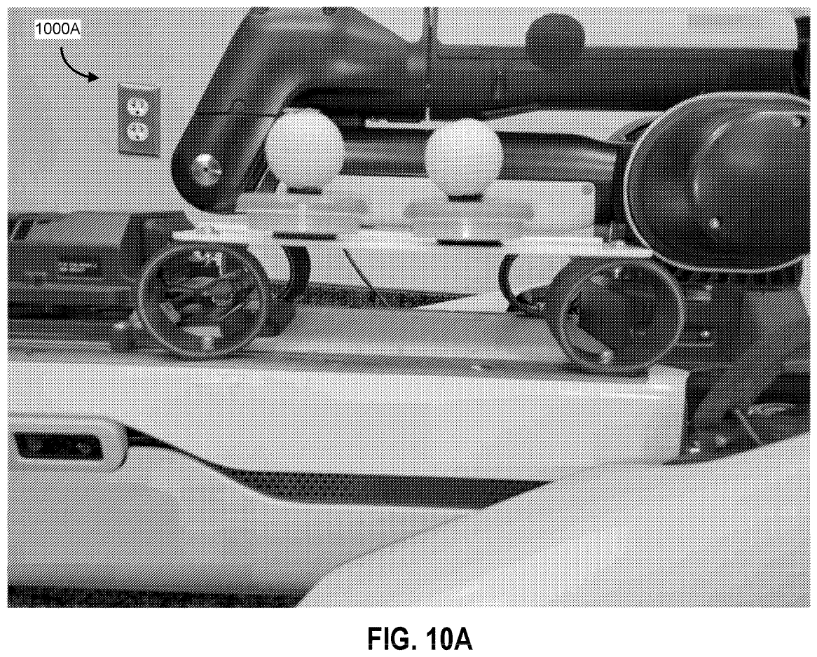

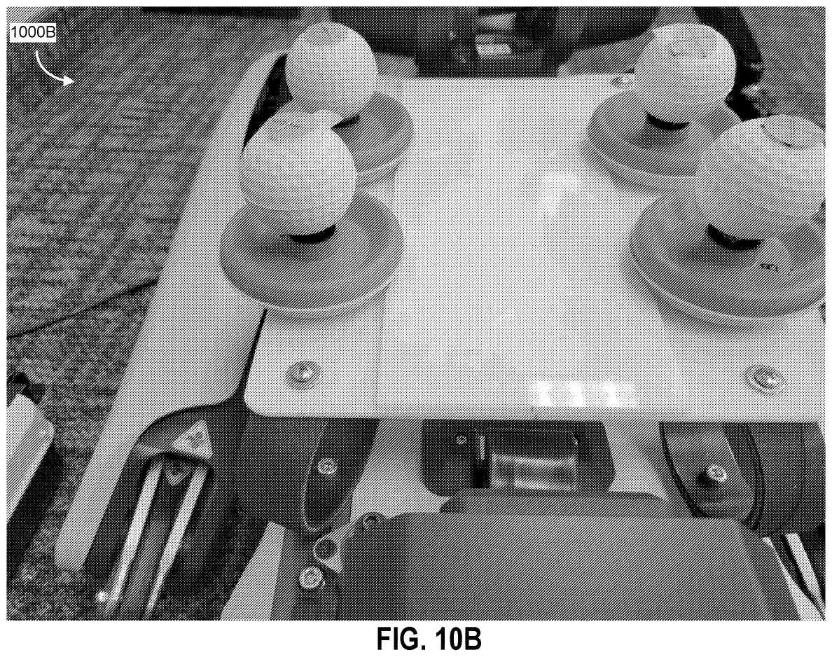

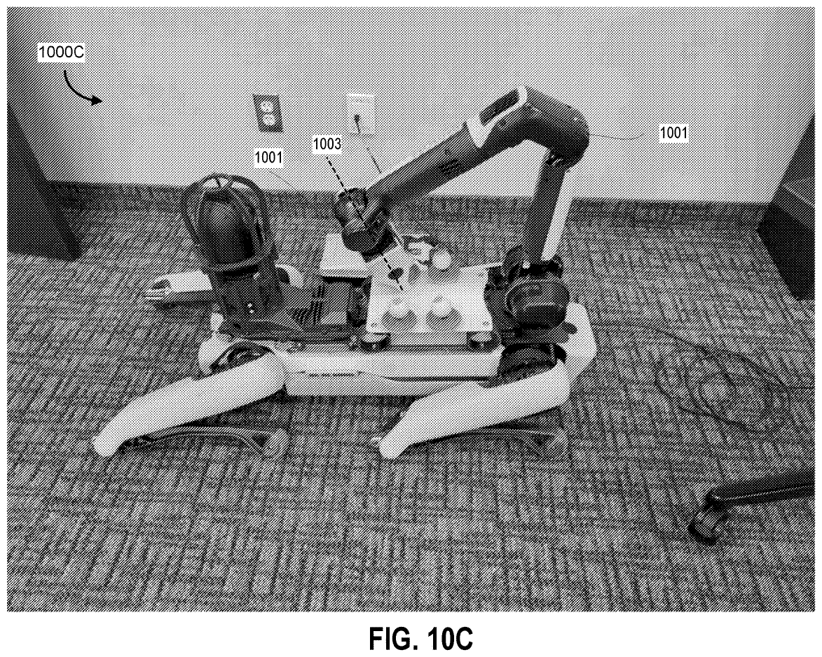

According to some embodiments, a robot arm and/or an end effector on the robot arm may have limited movement. For example, the robot arm may have a fixed length and may comprise a plurality of joints about which the arm may bend and/or rotate. In an example the robot arm and gripper may be Spot Arm™ provided by Boston Dynamics™, which may have six degrees of freedom plus the gripper. Other robot arms may be used according to this disclosure which may have different degrees of freedom. As shown in FIG. 10C, when the robot arm is positioned to allow an end effector of the robot arm to grasp an interface member of a grip assembly of a sampling container according to this disclosure, the longitudinal axis of the end effector may not be aligned with the longitudinal axis of the interface member. In other words, when in use, the end effector may positioned at various different angles with respect to the grip assembly. As shown in FIG. 10C, an end effector gripping a gripping assembly is illustrated and the longitudinal axis of the gripper assembly and end effector are not aligned. This non-alignment may occur when the sample container and sample tray are positioned on the robot as shown in FIG. 10C, when a sample is being gathered from a surface, or other circumstance. In other words, during use, the robot arm may only be able to position the end effector at an angle with respect to the longitudinal axis of the interface member which may cause difficulties for the end effector to grip the interface member. In an aspect, gripping members according to this disclosure may allow end effector to more firmly grip the gripper members when picked up and/or during sampling.

In some embodiments, a sample container interface member of a grip assembly, is described, which may allow the sample container interface member to be picked up by a robot arm or end effector at multiple angles and/or positions, which simplifies operation of the robot arm and end effector as the robotic arm and/or end effector does not need to be limited to an specific position to pick up the sample container interface member. The robot arm, and an end effector of the robot arm, may each have limited range of movement and may not be able to move to a position to grip and/or couple to a sample container when the sample container is oriented in certain positions. Additionally, once a sample container is gripped and picked up by an end effector, the robot arm and/or end effector may also have a limited range of move to place an entire sampling surface of the sample container into contact with a surface being sample. According to this disclosure, the sample container interface member, in some embodiments, may allow for multiple orientations/positions of the sample lid with respect to a surface being sampled, by allowing the lid to rotate and/or tilt with respect to the sample container interface member of a grip assembly, and end effector of the robot arm. This may provide an end effector on a robot arm an ability to greater range of movement for the robotic arm and end effector, and simply operation of the robotic arm and end effector, as exact positioning of the lid while collecting the sample is not required.

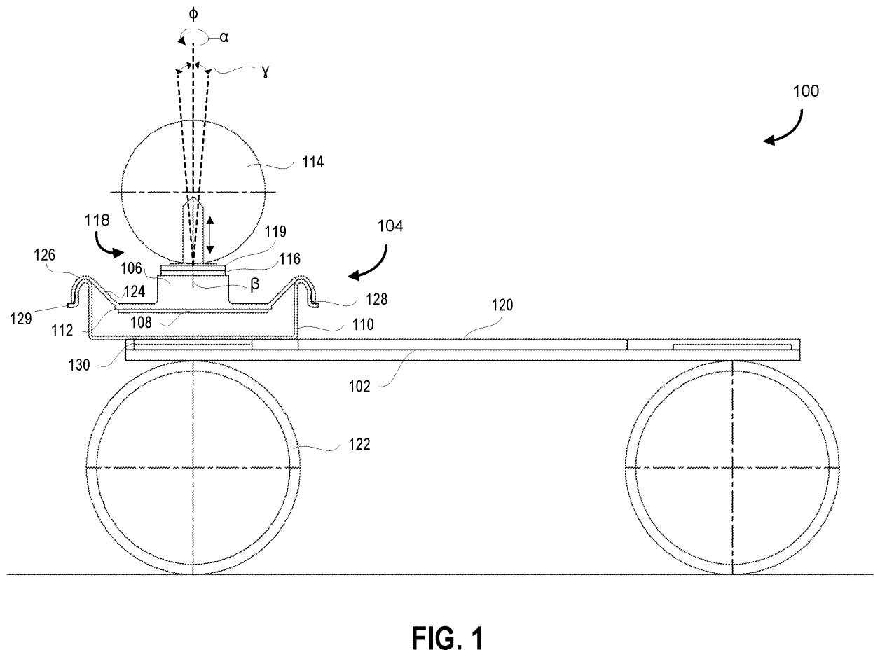

FIG. 1 is front view illustrating a system for radioactive sampling 100, according to some embodiments.

In an aspect, a system for radioactive contamination sampling 100 is provided that may have a mounting tray 102 configured to be coupled to a robot for deployment in a radioactive environment, and at least one sampling container 104 which may be releasably coupled to the mounting tray 102 to maintain a position of the at least one sampling container 104 during deployment of the robot.

For example, in some embodiments, the method of attaching and supporting the mounting tray 102, or a “sample tray,” may allow for vertical and lateral movement of the tray relative to the robot when interfacing with a robotic arm to prevent damage to the tray under normal operation or robot maloperation.

In said aspect, each of the at least one sampling containers, such as sampling container 104, may include a lid 106 which may have first side 112 defining a sampling surface for sampling a contaminated surface. In an embodiment, sampling surface may comprise a material for receiving a sample. In another embodiment, first side 112 may be configured for receiving sampling paper 108, and a cup 110. The surface may be configured to releasably couple the sampling paper 108 to a first side 112 of the container lid 106, and the first side 112 and the sampling paper 108 may each be configured to fit within an inner volume of the cup 110. The container lid 106 may be releasably coupled to the container cup 110 by a sealing surface to seal the sampling paper 108 within the inner volume and to prevent contamination of the sampling paper 108. The sampling paper 108 may be positioned to extend away from the first side 112 of the container lid 106, and the sampling paper 108 may be configured to collect a sample from a surface.

In some embodiments, sample container 104 may prevent cross contamination with sources other than the intended sample location. The sample container lid 106 and cup 110 may seal sufficiently to prevent contamination, such as contamination from contacting the sample from external sources. It may also ensure the used sample is separated from the environment until analyzed by humans in the intended instrument. The ability to remove the sample container 104 from the tray, in some embodiments, maintains the integrity of the sample in this way.

Further, in said aspect, the system for radioactive contamination sampling 100 may include an interface member 114 coupled to a second side 116 of the container lid 106. The interface member 114 may have a shape configured to be gripped by an end effector of the robot. Interface member may pivot about its coupling point with second side 116. In an example interface member may be coupled to second side 116 by a resilient material allowing interface member to pivot about the coupling point with second side 116. In an embodiment, interface member may be coupled to second side 116 with a hinge 118 configured to pivot a longitudinal axis of the interface member 114 at a first angle to a second axis orthogonal to a plane defined by the second side 116 of the container lid 106.

In some embodiments, the sample container interfacing mechanism, or grip assembly, may allow an end effector of the robot arm to interface and couple to the sample container interfacing mechanism, or grip assembly, in numerous positions and/or at numerous angle of approach. In an example, the angle of approach may be an angle of the end effector relative to the longitudinal axis φ of the sample container interfacing mechanism, or grip assembly, when the end effector grips the sample container interfacing mechanism, or grip assembly. In some embodiments, the sample container interfacing mechanism, or grip assembly, may include interface member 114, and hinge 118. This may allow for a range of positions of the end effector which may simplify robot operation both by human operation or programing. The interfacing mechanism may also provide rotational position of the sample disc during smearing, while collecting a sample for instance, which may simplify robot operation both by human operation or programing, by maintaining the sample disc, such as the sampling paper 108, in complete contact with the surface without requiring fine adjustment of the robot hand or end effector.

The ability to deploy multiple sample containers 104, in some embodiments, for each robot deployment, may provide the ability to obtain multiple samples for each robot deployment.

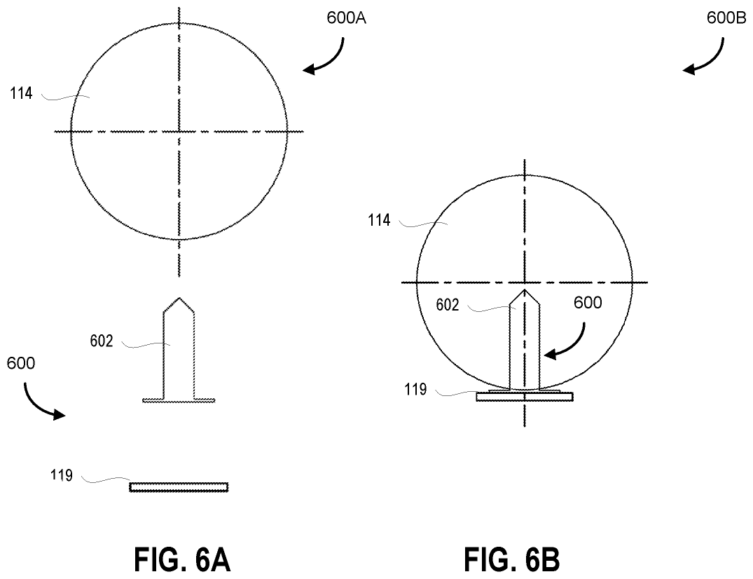

In another aspect, hinge 118 may comprise a hinge base 119 and a hinge anchor. A hinge anchor 602 may be seen in FIG. 6, for example. In some embodiments, interface member 114 may couple to a hinge 118, which may comprise a hinge anchor, such as hinge anchor 602, which may be rotatably coupled to a hinge base 119 to allow interface member 114 to tilt and/or rotate with respect to hinge base 119.

In another aspect, a system for radioactive contamination sampling, such as that shown in FIG. 1, is provided that may include at least one sampling container 104 which may be configured to be releasably coupled to a mounting tray 102 on a robot for deployment in a radioactive environment to maintain a position of the at least one sampling container 104 during deployment of the robot.

In said aspect, each of the at least one sampling containers 104 may have a lid 106 which may have a surface for receiving sampling paper 108, and a cup 110. The surface may be configured to releasably couple the sampling paper 108 to a first side 112 of the container lid 106, the first side 112 and the sampling paper 108 may each be configured to fit within an inner volume of the cup 110. The container lid 106 may be releasably coupled to the container cup 110 by a sealing surface to seal the sampling paper 108 within the inner volume and to prevent contamination of the sampling paper 108. The sampling paper 108 may be positioned to extend away from the first side 112 of the container lid, and the sampling paper 108 may be configured to collect a sample from a surface.

Further, in said aspect, the system for radioactive contamination sampling 100 may include an interface member 114 coupled to a second side 116 of the container lid 106. The interface member 114 may have a shape configured to be gripped by an end effector of the robot, for instance, and may have a hinge 118 configured to pivot longitudinal φ of the interface member 114 at a first angle γ to a second axis β orthogonal to a plane defined by the second side 116 of the container lid 106.

In an embodiment, interface member 114 may have a resilient compressible surface.

In an embodiment, the resilient compressible surface may have a frictional coefficient of greater than 0.4.

In an embodiment, the interface member 114 may have a generally spherical surface. In another embodiment, the interface member 114 may have a frustoconical shape. In another embodiment, the interface member 114 may have a generally circular cross-section.

In an embodiment, the mounting tray 102 may have a mounting surface 120 supporting the at least one sampling container 104, and the mounting tray 102 may be supported by at least one resilient mounting member 122 for absorbing compressive, tensile, and shear force.

In an embodiment, the first angle γ may be between 1-45 degrees.

In an embodiment, the hinge 118 may be configured to rotate the interface member 114 about the longitudinal axis through a second angle α.

In an embodiment, the second angle α may be between 1-45 degrees.

In an embodiment, the hinge 118 may be configured translate the interface member 114 axially along the longitudinal axis φ of the interface member 114.

In an embodiment, the hinge 118 may be a hook and loop fastener.

In an embodiment, the container lid 106 may include a shoulder 124 projecting away from the surface for receiving the sampling paper 108 on first side 112. The shoulder 124 may be coupled to a lip 126 having a concave surface for self-centering engagement with a rim 128 of the cup 110, and the rim 128 of the cup 110 may have a convex mating surface for engaging the concave surface of the lip.

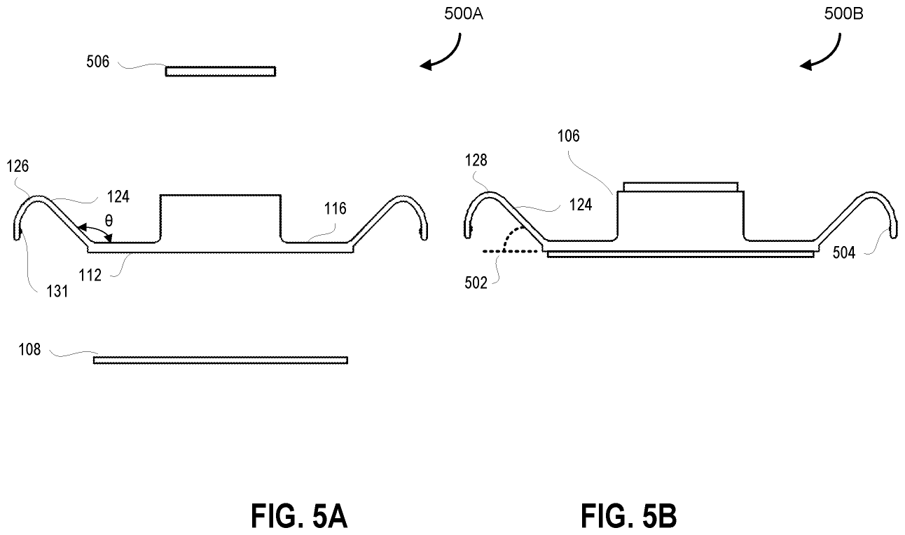

The shoulder 124, projecting away, may in some embodiments, project at an angle θ from a base portion of lid 106, such as first side 112 or second side 116 for example, wherein shoulder 124 does not intersect with a plane defined by the surface for receiving the sampling paper 108. In an embodiment, angle θ may be in a range from 90-180 degrees. In the illustrated example of FIG. 5A, shoulder 124 may project from a perimeter of second side 116 at an angle θ may be about 135 degrees.

In an embodiment, the shoulder 124 may have a ridge or a groove 131 for mating with a counterpart ridge or the groove on rim 128. In an example, shoulder 124 may comprise a ridge for coupling with a groove in rim 128, or vice-versa.

In an embodiment, the lip 126 having the concave surface may be configured to friction fit with the convex mating surface of the rim 128 of the cup 110.

In an embodiment, the rim 128 of the cup 110 may have a flange 129.

In some embodiments, the use of a system, such as the system for radioactive contamination sampling 100, may allow for the determination of the contamination levels within areas where the radiative conditions may be unknown, reducing and/or eliminating potential radiation exposure of humans associated with performing contamination sampling. This may be the case, for example, following unplanned events, such as radiological accidents, or areas that have not been tested for extended periods of time, which may require sampling.

In some embodiments, the use of a remote sampling system, such as the system for radioactive contamination sampling 100, can reduce the number of people required to determine the contamination levels of an area, such as a facility, by allowing one system to operate continuously for 24 hours a day, 7 days a week, with only a system operator. Determining the contamination level normally requires personnel on each shift and on weekends at premium pay rates. Reducing the number of required personnel can result in substantial cost savings.

In some embodiments, a remote sample system, such as radioactive contamination sampling system 100 may be used to determine the presence of any material in unintended place, such as chemicals or other non-radioactive materials. For example, the explosive level of dust such as aluminum powder at a fabrication facility, or chemical leaks at manufacturing plants.

The contamination sampling system 100, may, in some embodiments, be mounted on a robot using existing robot mounting fixtures, or any other mechanism appropriate to the type of robot.

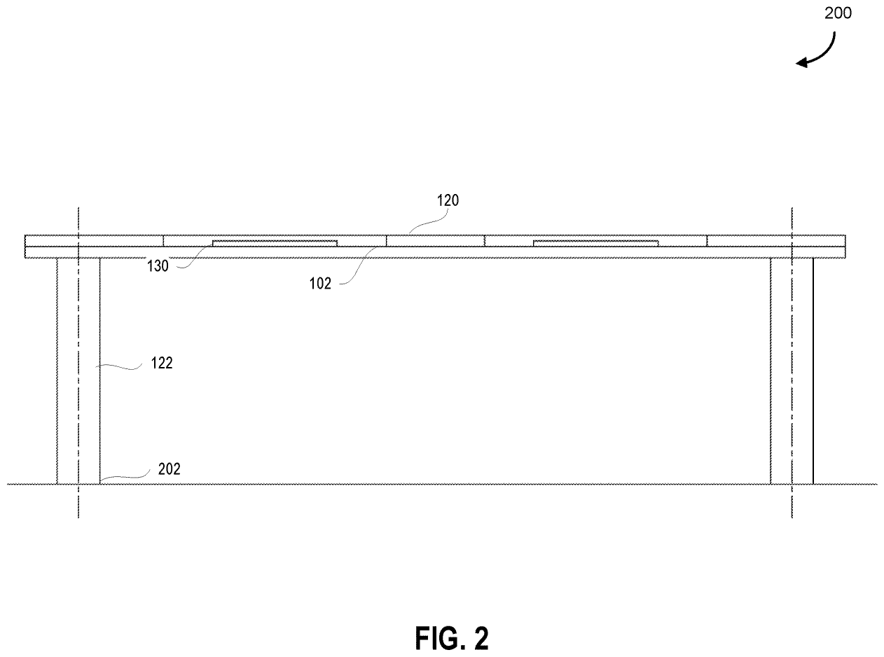

FIG. 2 is a side view 200 illustrating a mounting system, according to some embodiments. The mounting system shown in 200 may be mounting tray 102, according to some embodiments.

In an embodiment, the mounting tray 102 may have a mounting surface 120 supporting the at least one sampling container 104, and the mounting tray 102 may be supported by at least one resilient mounting member 122 for absorbing compressive, tensile, and shear force.

In some embodiments, mounting tray 102 may consist of a surface 120, onto which the sample containers 104 may be mounted. The containers 104 may be held in a position on the tray using a fixing device 130, which may be a hook and loop fastener, double sided tape, twist lock, adhesive, or the like. In some embodiments, mounting tray 102 may have a fixing device 130, and sample container 104 may have another fixing material, which may be similar to fixing device 130. For example, in some embodiments, sample container 104 may have a fixing material on cup 110, such as the hook side of a hook and loop fastener, and mounting tray 102 may have the appropriate loop counterpart fixing material of the hook and loop fastener.

The tray 102 may be a thin plastic sheet, for example one that is approximately 3/16″, or other thickness sheet, such as Plexiglass™, or a similarly suitable material. Mounting tray 102 may provide the needed strength to interface with the robot, for instance, while reducing the weight of the sampling system. Reducing weight of the sampling system is desirable.

In some embodiments, mounting tray 102 may be supported by a system of mounts, such as resilient mounting members 122, that support the tray and maintain its position laterally and vertically under normal operation. The system of mounts may prevent damage to the sampling system during unplanned robot events, and returns the mounting tray to a normal position following any unplanned event. For example, should the robot encounter rough or uneven terrain, the system of mounts, in some cases having at least one of resilient mounting members 122, may ensure that mounting tray 122 remains in a normal position, which may involve keeping the sampling containers 104 substantially upright and/or the mounting tray 122 substantially level (which may, in some cases, be level relative to a flat ground).

In some embodiments, resilient mounting members 122 may be rubber cylinders, for example, mounted horizontally and attached to the sample tray and the robot mount. In some embodiments, resilient mounting members 122 may be substantially hollow, and/or tubular in shape. In some embodiments, resilient mounting members 122 may be filled, rather than hollow. The orientation of said rubber cylinders may be positioned to ensure the lateral position of the tray returns to the normal position under normal or abnormal events. In other embodiments, other materials and configurations may be used as resilient mounting members 122, to ensure that mounting tray 122 may remain and/or return to a normal position, such as that described above. In some embodiments, mounting members 122 may be shock mounts which are flexible, and semi-firm hoses which may compress, twist, or rotate as required to support mounting tray 102.

In some embodiments, mounting members 122 may have lower mounting hardware 202, which may coupled the mounting members 122 to a robot, for example. In some embodiments, lower mounting hardware 202 may be screws, nails, hook and loop fasteners, among others. Lower mounting hardware 202, may in some embodiments, have different coupling methods corresponding to different robots, for example.

In some embodiments, the sample container 104 may be composed of a lid 106 and a cup 110. The sample material may be attached to the container lid 106.

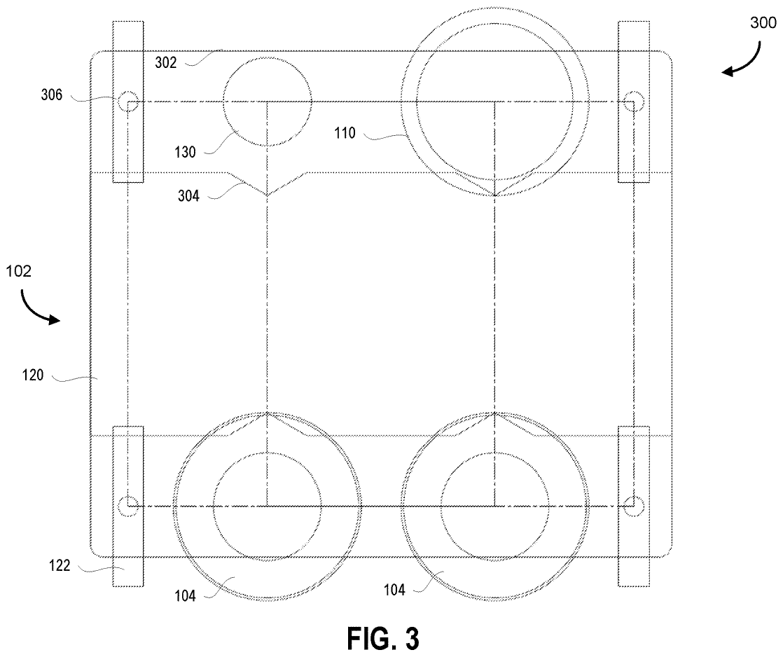

FIG. 3 is a top view 300 illustrating a system for radioactive sampling, according to some embodiments. The system shown in 300 may be radioactive sampling system 100, according to some embodiments.

Shown in 300, mounting members 122 can be seen supporting base plate 302. Base plate 302 may be a part of mounting tray 102, and may be underneath alignment plate 304. In some embodiments, mounting surface 120 may be on a side of base plate 302. In some embodiments, mounting surface may be on a side of alignment plate 304. In some embodiments, alignment plate 304 may align sample container 104, for example, at a level substantially in-line with mounting surface 120.

Top view 300 shows fixing device 130 in the top left corner position of mounting tray 102, a container cup 110 in the top right corner position, and sample containers 104 in both the bottom corners. As shown, mounting tray 102 may have four positions to mount a sample container 104. In other embodiments, mounting tray 102 may have one or more positions to mount a sample container 104.

In some embodiments, mounting members 122 may be shock mounts, and may rotate as required to support mounting tray 102, as described above. Mounting members 122 may be coupled to mounting tray 102 by upper mounting hardware 306. In some embodiments, upper mounting hardware 306 may be screws, nails, hook and loop fasteners, among others.

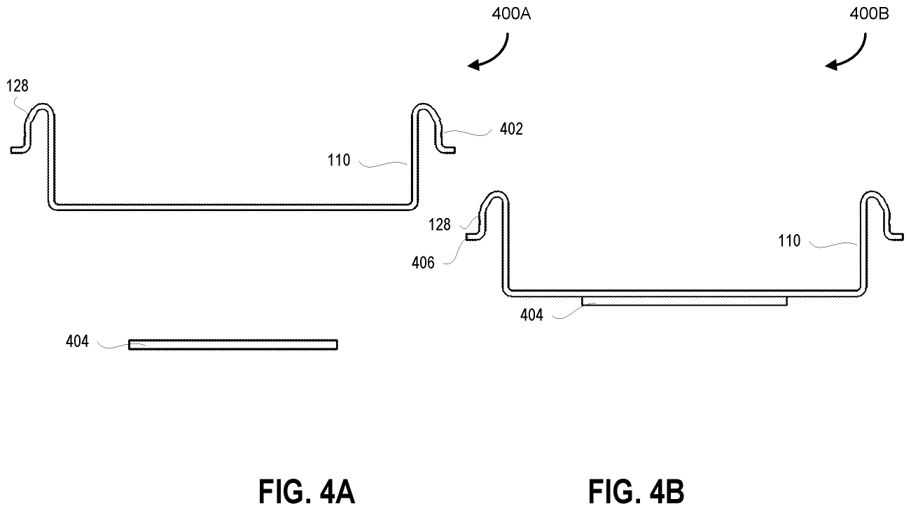

FIG. 4A is a fragmented view 400A illustrating a sample container cup, according to some embodiments and FIG. 4B is an assembled view 400B illustrating sample container cup, according to some embodiments. The sample cup shown in 400A and 400B may be similar to container cup 110.

The container cup 110 may, in some embodiments, be in the form of a shallow container, or other suitable shapes. Cup 110 may be made of a low-cost light-weight material, such as plastic, but any suitable material may be used. Cup 110 may provide an interface 404 with the tray 102 and the container lid 106. The interface 404 with the tray 102 may maintain the sample container 104 position during normal and abnormal operations, while allowing for simple and rapid removal and installation of sample containers 104. Interface 404 may be similar to fixing device 130, and may couple to fixing device 130. In some embodiments, the coupling may be accomplished using a connection material, such as a hook-and-loop fastener; however, any other suitable coupling material or devices may be used. Cup 110 may also provide a sealing surface to which lid 106 may be supported, and seal to prevent cross contamination of the sample.

In an embodiment, the rim 128 of the cup 110 may have a flange, such as flange 406. In some embodiments, rim 128 may include a ridge or groove. For example, groove 402 can be seen in FIG. 4A. In some embodiments, lid 106 may have a groove similar to groove 402 shown on cup rim 128. In some embodiments, cup rim 128 may have a similar ridge 504, while lid shoulder 124 may have a groove similar to groove 402.

FIG. 5A is a fragmented view 500A illustrating a sample container lid and swab holder, according to some embodiments, and FIG. 5B is an assembled view 500B illustrating a sample container lid and swab holder, according to some embodiments. The container lid shown in 500A and 500B may be similar to container lid 106.

The container lid 106 may, in some embodiments, be in the form of a flat plate with features to seal to cup 110, support the sampling paper 108, and interface with the lifting feature (e.g., a robot arm lifting lid 106). Lid 106 may take any other suitable shape to cover and seal the cup, support the sampling paper 108, and interface with the lifting feature.

In some embodiments, lid 106 may be manufactured from plastic, although any other suitable material may be used to provide the needed shape, strength, and weight. Lid 106 may seal to cup 110 with applied force, from a robotic arm for example, and lid 106 may be held in place through the sealing mechanism. This may prevent loss of lid 106 and the sample, under both normal and abnormal operations. In some embodiments, the sampling paper 108 may be attached to the underside of lid 106, to first side 112 for instance, protruding from first side 112 sufficiently to allow the sampling paper 108 to contact the surface to be sampled without lid 106 touching the surface, for example, which may interfere with the measured contamination level. Interference with measuring the contamination level is undesirable.

In some embodiments, the container lid 106 may include a shoulder 124 projecting away from the surface for receiving the sampling paper 108. Shoulder 124 may be coupled to lip 126 having a concave surface for self-centering engagement with rim 128 of the cup 110, and the rim 128 of the cup 110 may have a convex mating surface for engaging the concave surface of the lip.

The shoulder 124, projecting away, may in some embodiments, project at an angle from a base portion of lid 106, such as first side 112 or second side 116 for example, wherein shoulder 124 does not intersect with a plane defined by the surface for receiving the sampling paper 108. Angle 502 can be seen denoted in FIG. 5B.

In some embodiments, the shoulder 124 may have a ridge or a groove for mating with the other of the ridge or the groove, and the rim 128 may include the other of the ridge or the groove. For example, ridge 504 can be seen in FIG. 5B. In other embodiments, lid 106 may have a groove similar to groove 402 shown on cup rim 128. In some embodiments, cup rim 128 may have a ridge similar ridge 504, while lid shoulder 124 may have a groove similar to groove 402.

In some embodiment, the lip 126 having the concave surface may be configured to friction fit with the convex mating surface of the rim 128 of the cup 110.

In some embodiments, a fixing device 506 may be coupled to second side 116 of lid 106. In some embodiments, fixing device 506 may be a part of hinge 118. In other embodiments, fixing device 506 may be coupled or releasably coupled to hinge 118. Fixing device 506 may be a hook and loop fastener, double sided tape, twist and lock mechanism, a latch assembly, or the like.

FIG. 6A is fragmented view 600A illustrating an gripping assembly, according to some embodiments, and FIG. 6B is an assembled view 600B illustrating an gripping assembly, according to some embodiments. The grip assembly shown in 600A and 600B may be similar to that described, such as a mechanism with interface member 114 and hinge 118.

Sample container 104, may in some embodiments, have an interfacing mechanism, which may include interface member 114 coupled to hinge base 119. In some embodiments, interface member 114 may couple to a hinge 600, which may comprise a hinge anchor 602 which may be rotatably coupled to a hinge base 119 to allow interface member 114 to tilt and/or rotate with respect to hinge base 119. In some embodiments, hinge anchor 602 may be threaded to coupled with interface member 114. In some embodiments, hinge anchor 602 may have course threads to prevent pull-out of anchor 602 from interface member 114, for example. In some embodiments, hinge anchor 602 may be a flexible material, such as rubber or plastic to allow for rotation as described above. Said interfacing mechanism may consist of a robot hand interfacing feature, for example, and a rotational motion feature. Such an gripping assembly may provide for gripping the sample container 104 using any design variation of a robot hand, for example. It may allow for a level of compression and frictional force, to allow the robot hand, for example, to compress interface member 114 while accommodating the force applied. Friction may also provide the force necessary to prevent slipping, and potential dropping of sample container 104, and of lid 106 while performing smearing operations collecting a sample, by maintaining the position of lid 106.

In some embodiments, hinge 118 may provide said gripping assembly with a rotational feature. In some embodiments, the rotation feature of said interface member may allow for a range of rotational motion of container lid 106 during retrieval and return of the lid 106, by the robotic arm for example, as well as during the smear operation while collecting a sample, for example. This may ensure the necessary rotational position of the lid can be achieved during smearing operation to ensure the entire sampler 104 may be maintained in contact with the sampled surface, under various robot arm positions and movements, for instance.

The rotation feature may also allow, in some embodiments, the needed rotational position during retrieval and return of lid 106, by allowing rotation to match the orientation of sample container cup 110. This may allow proper positioning of the sample container lid 106 without requiring an exact positioning of the robotic arm, for example.

The rotational feature may be removable from the sample container 104, which may allow it to be reused when containers are replaced. For example, in some embodiments, hinge 118 and interface member 114 may be removable from lid 106.

In some embodiments, interface member may have a resilient compressible surface. For example, in some embodiments, the resilient compressible surface may have a frictional coefficient of greater than 0.4. In other embodiments, the resilient compressible surface of the interface member, such as interface member 114, may have a different frictional coefficient.

In some embodiments, the interface member may have a generally spherical surface. In some embodiments, the interface member may have a frustoconical shape. In some embodiments, the interface member may have a generally circular cross-section. The interface member may, according to other embodiments, have different shapes corresponding to different end effectors of the robot, for example.

Interface member 114 may tilt such that longitudinal axis φ of Interface member 114 is at a first angle γ with respect to axis β; and may rotate about longitudinal axis φ of interface member 114 at a second angle α. In some embodiments, the first angle provided by the gripping assembly may be between 1-45 degrees. In some embodiments, hinge 118 may be configured to rotate the interface member 114 about the longitudinal axis φ through a second angle. In some embodiments, said second angle may be between 1-45 degrees. In some embodiments, the hinge 118 may be configured translate the interface member 114 axially along the longitudinal axis φ of the interface member 114. In some embodiments, the first and second angles of movement by the gripping assembly may be more or less than 1-45 degrees.

In some embodiments, hinge 118 and/or hinge 600, for example, may be a hook and loop fastener, among other fastening members. In some embodiments, hinge base 119 may comprise a hook and loop fastener for hinge 118, for instance. In some embodiments, hinge anchor 602 may be coupled to hinge base 119 by glue.

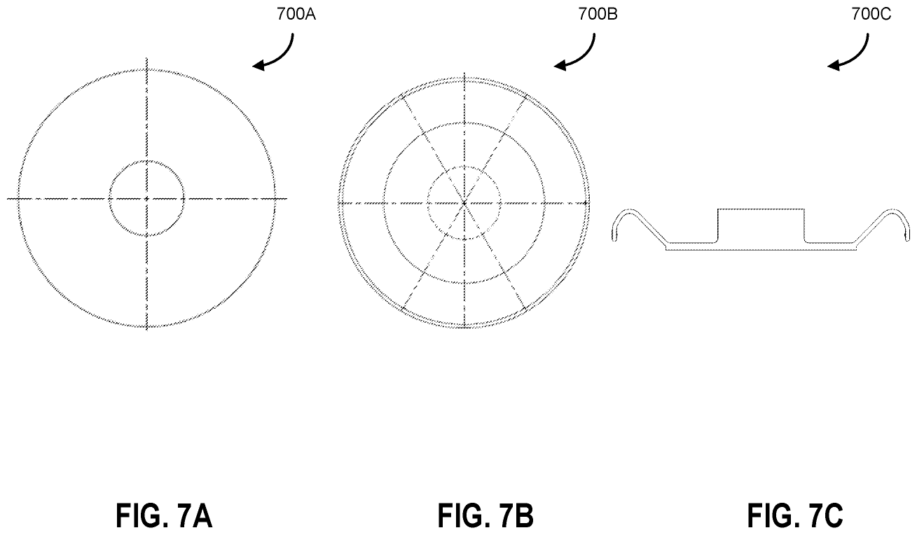

FIG. 7A is a top view 700A illustrating a sample container lid, according to some embodiments, FIG. 7B is a bottom view 700B illustrating a sample container lid, according to some embodiments, and FIG. 7C is a front view 700C illustrating a sample container lid, according to some embodiments. The sample container lid shown in FIGS. 7A-7C may be similar to container lid 106.

As can be seen in 700A and 700B, the container lid may be substantially circular in shape, in some embodiments. In other embodiments, not shown, the container lid may be a different shape. In some embodiments, the shape of the container lid is substantially similar to the outer shape of the container cup, where the container lid may be sealed to the container cup.

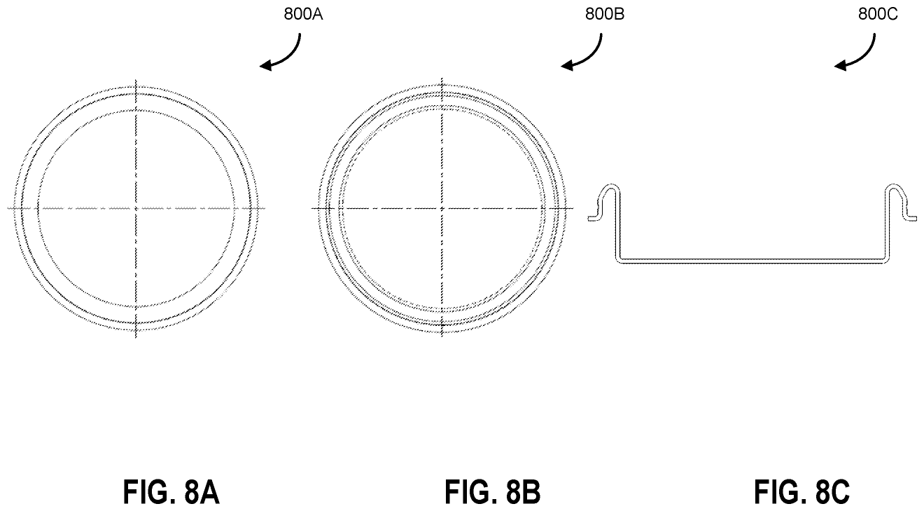

FIG. 8A is a top view illustrating a sample container cup, according to some embodiments, FIG. 8B is a bottom view illustrating a sample container cup, according to some embodiments, and FIG. 8C is a front view illustrating a sample container cup, according to some embodiments. The sample container cup shown in FIGS. 8A-8C may be similar to container cup 108.

As can be seen in 800A and 800B, the container cup may be substantially circular in shape, in some embodiments. In other embodiments, not shown, the container cup may be a different shape. In some embodiments, the shape of the container lid is substantially similar to the outer shape of the container cup, where the container lid may be sealed to the container cup.

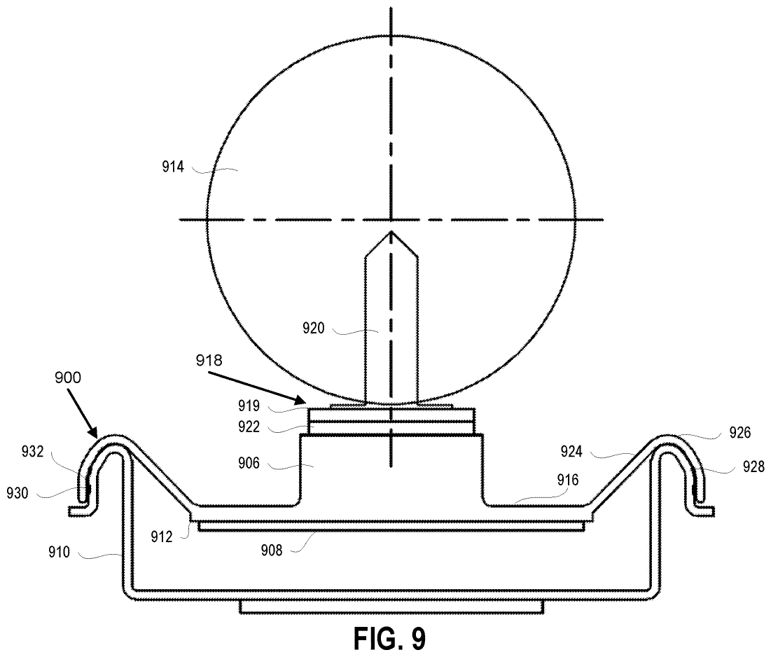

FIG. 9 is an assembled view illustrating a sample container 900, according to some embodiments. Sample container 900 may be similar to sample container 104 shown in FIG. 1, and may, in some embodiments, have similar components.

In the shown embodiment, a sampling container 900 is provided, which may be configured to be releasably coupled to a mounting tray, such as 102, on a robot for deployment in a radioactive environment to maintain a position of sampling container 900 during deployment of the robot, for example.

Sampling container 900 may have a lid 906 which may have a surface for receiving sampling paper 908, and a cup 910. The surface may be configured to releasably couple the sampling paper 908 to a first side 912 of the container lid 906. The first side 912 and the sampling paper 908 may each be configured to fit within an inner volume of the cup 910. The container lid 906 may be releasably coupled to the container cup 910 by a sealing surface to seal the sampling paper 908 within the inner volume and to prevent contamination of the sampling paper 908. The sampling paper 908 may be positioned to extend away from the first side 912 of the container lid, and the sampling paper 908 may be configured to collect a sample from a surface.

In some embodiments, sampling container 900 may include an interface member 914 coupled to a second side 916 of the container lid 906. The interface member 914 may have a shape configured to be gripped by an end effector of the robot, for instance, and may have a hinge 918 configured to pivot a longitudinal axis of the interface member 914 at a first angle to a second axis orthogonal to a plane defined by the second side 916 of the container lid 906. In some embodiments, sample container 900 may include hinge anchor 920. In some embodiments, hinge 918 may be coupled or releasably coupled to hinge anchor 920.

In some embodiments, a fixing material 922 may be coupled to second side 916 of lid 906. In some embodiments, fixing material 922 may be a part of hinge 918. In other embodiments, fixing material 922 may be coupled or releasably coupled to hinge 918. Fixing material 922 may be a hook and loop fastener, double sided tape, or the like.

In some embodiments, the container lid 906 may include a shoulder 924 projecting away from the surface for receiving the sampling paper 908. The shoulder 124 may be coupled to a lip 926 having a concave surface for self-centering engagement with a rim 928 of the cup 910, and the rim 928 of the cup 910 may have a convex mating surface for engaging the concave surface of the lip.

The shoulder 924, projecting away, may in some embodiments, project at an angle from a base portion of lid 906, such as first side 912 or second side 916 for example, wherein shoulder 924 does not intersect with a plane defined by the surface for receiving the sampling paper 108. In some embodiments, the shoulder 924 may have a ridge or a groove for mating with the other of the ridge or the groove, and the rim 928 may include the other of the ridge or the groove. This may be seen in FIG. 9, where for example, groove 930 of cup 910 is mating with ridge 932 of lid 906.

In other embodiments not shown, lid 906 may have a groove similar to groove 930 shown on cup rim 928. In some embodiments, cup rim 928 may have a ridge similar ridge 932, while lid shoulder 924 may have a groove similar to groove 930. In some embodiment, the lip 926 having the concave surface may be configured to friction fit with the convex mating surface of the rim 928 of the cup 910.

FIG. 10A is an image showing an example system 1000A for radioactive sampling implemented on a robot, according to some embodiments. FIG. 10B is an image showing an example system 1000B for radioactive sampling implemented on a robot, according to some embodiments. FIG. 10C is an image showing an example system 1000C for radioactive sampling implemented on a robot, according to some embodiments. The robot has a robot arm 1001 having an end effector 1002 with a longitudinal axis 1003.

As shown, in some embodiments, the mounting tray may be coupled to a robot for deployment in a radioactive, or dangerous environment, to perform smearing to collect a sample without exposing a human to said dangerous environment. In some embodiments, the robot may be remote-operated by a user in a control-center, for example. In some embodiments, the robot may be operated autonomously, and may perform sample collection operations without human input.

The shown systems for radioactive sampling, according to some embodiments, in FIGS. 10A-10C may be similar to the system 100 described above and shown in FIG. 1. The sample container, may also, in some embodiments, be similar to sample container 900.

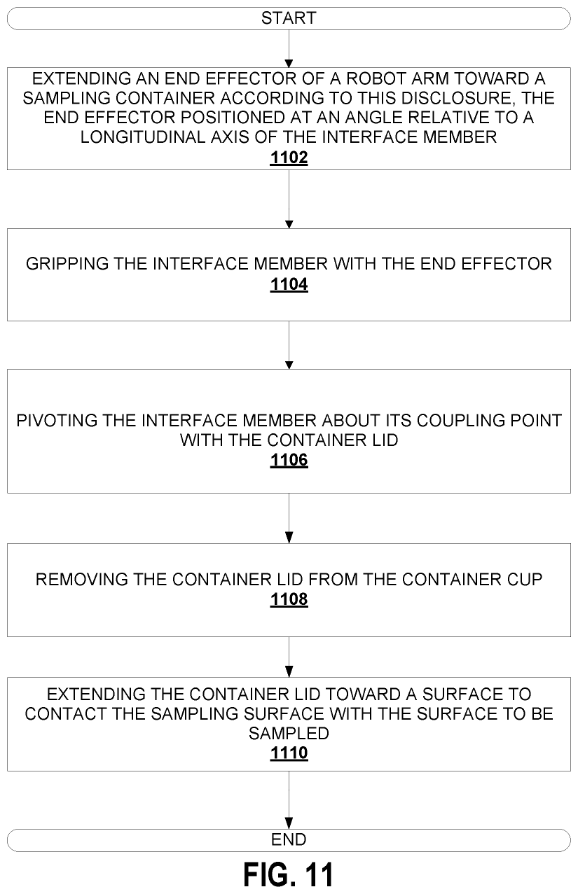

With reference to the method flow chart of FIG. 11, some embodiments may provide for a method for radioactive contamination sampling. In an aspect, the method be performed with the samples containers according to this disclosure.

At 1102, an end effector of a robot arm may be extended toward a sampling container according to disclosure. The end effector may be positioned at an angle relative to a longitudinal axis φ of the interface member of the sampling container (described above with respect to FIG. 1). In an embodiment, the angle is 1-45 degrees. The angle may be referred to as an ‘approach angle’ of the end effector toward the interface member, where the approach angle is the angle between the longitudinal axis φ of the interface member and the longitudinal axis 1003 of the end effector.

At 1104, the interface member is gripped with the end effector.

At 1106, the interface member is pivoted about its coupling point with the container lid.

At 1108, the container lid is removed from the container cup.

At 1110, the container lid is extended toward a surface to be sampled to contact the sampling surface with the surface to be sampled.

In an embodiment, the method may comprise coupling the container lid with the container cup to seal the sampling surface inside the sampling container.

In an embodiment, the method may comprise contacting the sampling surface with the surface to be sample. The longitudinal axis of the interface member may be at an angle relative to the surface to be sample. In an embodiment, the angle relative to the surface to be sample is between 45-90 degrees.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus-or step-plus-function limitations, unless such a limitation is explicitly recited in a given claim using the phrase(s) “means for” or “step for,” respectively.

1. A system for radioactive contamination sampling, comprising:
at least one sampling container configured to be releasably coupled to a mounting tray on a robot for deployment in a radioactive environment to maintain a position of the at least one sampling container during deployment of the robot;
each of the at least one sampling container comprising:
a lid having a sampling surface for receiving a sample, and a cup, the sampling surface positioned on a first side of the container lid, the first side and the sampling surface each configured to fit within an inner volume of the cup, the container lid releasably coupled to the container cup by a sealing surface to seal the sampling surface within the inner volume and to prevent contamination of the sampling surface, the sampling surface positioned to extend away from the first side of the container lid, the sampling surface configured to collect a sample from a surface;
an interface member coupled to a second side of the container lid, the interface member having a shape configured to be gripped by an end effector of the robot, wherein the interface member is configured to pivot about the coupling with container lid.

2. The system of claim 1, comprising a hinge configured to pivot a longitudinal axis of the interface member at a first angle relative to a second axis orthogonal to a plane defined by the second side of the container lid, wherein the first angle is between 1-45 degrees.

3. (canceled)

4. The system of claim 2, wherein the hinge is configured to rotate the interface member about the longitudinal axis through a second angle, wherein the second angle is between 1-45 degrees.

5. (canceled)

6. The system of claim 2, wherein the hinge is configured translate the interface member axially along the longitudinal axis of the interface member.

7. The system of claim 2, wherein the hinge is a hook and loop fastener.

8. The system of claim 1, wherein the sampling surface is configured to receive a sample paper.

9. The system of claim 1, wherein the interface member comprises a resilient compressible surface, wherein the resilient compressible surface has a frictional coefficient of greater than 0.4.

10. (canceled)

11. The system of claim 1, wherein the interface member has at least one of a substantially spherical surface, a frustoconical shape, and a generally circular cross-section.

12. (canceled)

13. (canceled)

14. The system of claim 1, comprising the mounting tray configured to be coupled to a robot for deployment in a radioactive environment, wherein the mounting tray has a mounting surface supporting the at least one sampling container, the mounting tray supported by at least one resilient mounting member for absorbing compressive, tensile, and shear force.

15. The system of claim 1, wherein the container lid comprising a shoulder projecting away from the sampling surface for receiving the sampling paper, the shoulder coupled to a lip having a concave surface for self-centering engagement with a rim of the cup; and wherein the rim of the cup comprises convex mating surface for engaging the concave surface of the lip.

16. The system of claim 15, wherein the shoulder comprises a ridge or a groove for mating with the other of the ridge or the groove, and the rim comprises the other of the ridge or the groove.

17. The system of claim 15, wherein the lip having the concave surface is configured to friction fit with the convex mating surface of the rim of the cup.

18. The system of claim 15, wherein the rim of the cup comprises a flange.

19. The system of claim 15, wherein the sampling surface is configured to releasably couple the sampling paper to a first side of the container lid with a fixing device.

20. The system of claim 14, comprising the robot for deployment in a radioactive environment, the robot comprising the end effector coupled to an arm, wherein the mounting tray is coupled to the robot and positioned to be reachable by the arm.

21-37. (canceled)

38. A method for radioactive contamination sampling, the method comprising:
extending an end effector of a robot arm toward the sampling container of the system of claim 1, the end effector positioned at an angle relative to a longitudinal axis of the interface member;
gripping the interface member with the end effector;
pivoting the interface member about its coupling point with the container lid;
removing the container lid from the container cup;
extending the container lid toward a surface to be sampled to contact the sampling surface with the surface to be sampled.

39. The method of claim 38, wherein the angle is 1-45 degrees.

40. The method of claim 38, comprising coupling the container lid with the container cup to seal the sampling surface inside the sampling container.

41. The method of claim 38, comprising contacting the sampling surface with the surface to be sample, wherein the longitudinal axis of the interface member is at an angle relative to the surface to be sampled.

42. The method of claim 41, wherein the angle relative to the surface to be sampled is between 45-90 degrees.
